(19) United States
(12) Patent Application Publication
(10) Pub. No.: US 2004/0184072 A1
(43) Pub. Date: Sep. 23, 2004

(54) Storing and accessing thumbnail images corresponding to print jobs

(76) Inventors: Dana A. Jacobsen, Boise, ID (US); Terry-Lee M. Fritz, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/393,058

(22) Filed: Mar. 19, 2003

(51) Int. Cl. G06F 15/00

(52) U.S. Cl. 358/1.15; 358/1.16

(57) ABSTRACT

Systems and methods are disclosed herein for providing access to stored print jobs on imaging devices. An example of an imaging device, configured for connection to a network, comprises a processor that is configured to receive print jobs via the network. The imaging device further comprises a thumbnail image generator that creates a thumbnail image of each page of a print job received by the processor. The thumbnail images are accessible to workstations connected to the network. The imaging device also comprises a print job memory that stores the print jobs received by the processor. In one example, the processor comprises a web server for providing access to print jobs stored on the imaging device. The web server receives a request from a workstation connected to a network, accesses thumbnail images stored in a thumbnail image memory, and downloads web pages comprising thumbnail images corresponding to the pages of the print jobs to a browser in the workstation.

### BACKGROUND

In an environment such as an office, library, or other facility where several computer workstations are connected in a network, one or more printers are often connected to the network to allow computer users to print files or documents. These network printers may be any type of printer, such as laser printers, for example, and can vary with regard to resolution, quality, speed, price, etc.

Typically, to initiate a printing operation, a workstation converts a file to be printed into a Page Description Language (PDL) format that is readable by the printer. For example, the PDL format may be Adobe's Portable Document Format (PDF) or PostScript, Hewlett-Packard Company's Printer Control Language (PCL), or other suitable format. The workstation sends the PDL file to the printer, which receives the file and renders page frames that contain bitmap data used by the printer to print the pages of a requested print job. The term “print job” generally refers to a received PDL file or document that is printed. A print job is typically divided into whole pages and may include any number of pages.

In addition to the printer's actual printing components, which include electronic and mechanical parts responsible for creating text and images on paper, one element that has been added to printers is a front panel display. The front panel display is a small screen, typically having liquid crystal display (LCD) elements, displaying information about the printer or about the print job in progress. Another element that has been added to mid-range to high-end printers is a web server that has the capability to perform network functions, e.g., sending an e-mail message to a repair technician when service to the printer is required.

Another recent development in printers is the addition of a mechanism for storing print jobs. The print jobs can be stored in the PDL format or in the page-frame format. With the print jobs stored on the printer, a user may request to reprint one of the stored print jobs. However, since accessing and selecting the stored print jobs can at times be an inconvenient process, further development would be desirable to more efficiently manage print jobs.

Furthermore, each page of a print job stored in the page-frame format typically contains several megabytes (MB) of data. For example, for a printer having a resolution of 600 dpi (dots per inch), each square inch on the printed page includes 600×600 (or 360,000) dots or picture elements, i.e., pixels. Since each monochrome pixel typically includes one byte of data, a typical printed monochrome page may consume greater than 32 MB of data. Since each color pixel typically includes three bytes of data, a single color page may consume 96 MB or more. Thus, to store one thousand monochrome page frames on a printer, the printer must be capable of storing at least 32 gigabytes (GB) of data. It would therefore be beneficial in the printing industry to provide further developments in an effort to more efficiently manage print jobs stored on a printer or imaging device.

### SUMMARY

The present disclosure describes systems and methods for managing print jobs stored on an imaging device. One example of an imaging device, configured for connection in a network, comprises a processor that is configured to receive print jobs via the network. The imaging device comprises a thumbnail image generator that creates a thumbnail image of each page of the print jobs received by the processor. The thumbnail images are accessible to workstations that are also connected to the network. The imaging device further comprises a print job memory that stores the print jobs received by the processor.

The present disclosure also describes a web server for providing access to print jobs stored on an imaging device. The web server comprises means for receiving a request from a workstation connected in a network and means for accessing thumbnail images stored in a thumbnail image memory. Each thumbnail image corresponds to a page of a print job. The web server further comprises means for downloading web pages, comprising thumbnail images corresponding to the pages of the print jobs, to a browser in the workstation.

One method of managing print jobs, as described herein, comprises creating a thumbnail image from a print job, storing the print job in a print job memory, storing the thumbnail image on an accessible storage medium, and accessing the thumbnail image stored on the accessible storage medium.

### BRIEF DESCRIPTION OF THE DRAWINGS

The disclosed systems and methods can be better understood with reference to the following drawings. Like reference numerals designate corresponding parts throughout, the several views.

FIG. 1 is a block diagram illustrating a general representation of an example of a printing system in accordance with the present disclosure.

FIG. 2 is a block diagram of a first embodiment of one of the imaging devices shown in FIG. 1.

FIG. 3 is a block diagram of a second embodiment of one of the imaging devices shown in FIG. 1.

FIG. 4 is a block diagram of a first embodiment of one of the memory devices shown in FIG. 1.

FIG. 5 is a block diagram of a second embodiment of one of the memory devices shown in FIG. 1.

FIG. 6 is a block diagram of an exemplary embodiment of the processor shown in FIGS. 2 and 3.

FIG. 7 is a block diagram of an exemplary embodiment of one of the memory processors shown in FIGS. 4 and 5.

FIG. 8 is a block diagram of an exemplary embodiment of one of the workstations shown in FIG. 1.

FIG. 9 illustrates a first screen display showing an exemplary web page on the display device shown in FIG. 8.

FIG. 10 illustrates a second screen display showing another exemplary web page on the display device shown in FIG. 8.

### DETAILED DESCRIPTION

A recent development in the field of imaging devices (e.g., printers) includes the addition of a memory device built into the imaging devices with the ability to save, or store, print jobs. However, further developments are needed to better manage the stored print jobs. In order to provide access to the stored print jobs, one solution has been contemplated in which information about each stored print job is displayed on the front panel display. The displayed information may contain a name of the print job file, the author, and the date that the print job file was stored in memory. Accessing stored print jobs using the front panel display is an inexpensive solution for low-end imaging devices or imaging devices that do not have web servers. However, since the front panel display is typically very small, as mentioned earlier, a limited amount of information can be displayed at one time. Also, accessing large files can be somewhat time-consuming.

Another improvement to imaging devices has been contemplated in which thumbnail images can be created while the imaging device is printing. The term “thumbnail image” used herein refers to a miniature version of a larger image. In the case of a full image of a printed page, a thumbnail image of the full page is a fraction of the size and resolution of the full image. The thumbnail images may be shown on the front panel display, indicating to a person standing next to the imaging device the page that is currently being printed. These thumbnail images can be created for illustrating the current print job and are used only while the imaging device is printing the corresponding print job.

The management of print jobs using the disclosed systems and methods will now be discussed. By creating a thumbnail image of each page of each print job, imaging devices can be further improved by using the thumbnail images to manage print jobs. For instance, as disclosed herein, the thumbnail images may be stored for later use. In this regard, a correlation between the stored thumbnail images and the stored print jobs is established in order to link the thumbnail images with the corresponding print jobs.

Instead of creating thumbnail images for temporary use, the thumbnail images are stored on a storage medium, as disclosed herein. With the thumbnail images saved on an accessible storage medium, a management tool is further provided, allowing a user to manage stored print jobs by accessing the thumbnail images. For imaging devices connected to a network, the management tool provides access to the stored thumbnail images from a remote workstation on the network, as opposed to requiring a user to go to the imaging device and use the front panel on the imaging device. Since thumbnail images may be stored using far less memory than that used for the pages of the print job, access to the print jobs using the corresponding thumbnail images can be much quicker and simpler. Aspects will now be discussed in greater detail with respect to the following figures.

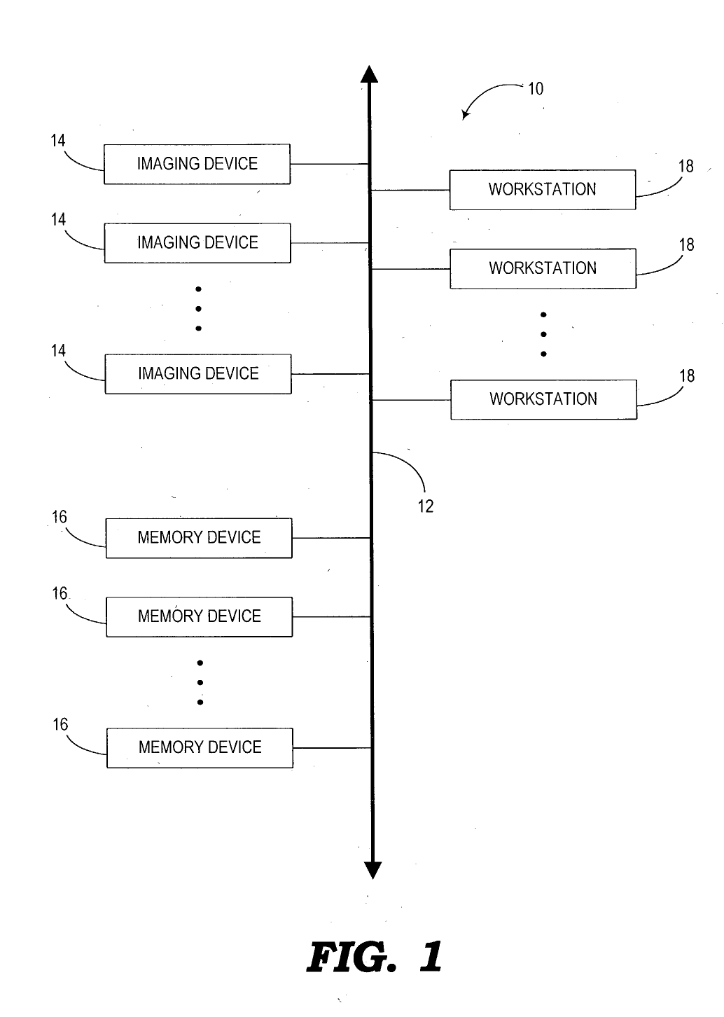

FIG. 1 is a schematic block diagram of a network printing system 10. The network printing system 10 includes imaging devices 14, remote memory devices 16, and workstations 18 linked together by a communication link 12. Communication link 12 represents generally any suitable means for carrying information between imaging devices 14, remote memory devices 16, and workstations 18. The network printing system 10 may be a local area network (LAN), the Internet (i.e., the World Wide Web), or other type of wired or wireless network. The imaging devices 14 may be laser printers, inkjet printers, dot-matrix printers, or other suitable types of printers. Moreover, the imaging devices 14 may comprise other devices capable of generating hardcopy outputs, such as photocopiers, multi-function peripheral (MFP) devices, facsimile machines, etc.

The memory devices 16 shown in FIG. 1 represent memory or storage media connected to the communication link 12. The memory devices 16 may be internal to the imaging devices 14 and/or workstations 18 or, as is shown, may be remote from the imaging devices 14 and workstations 18. These memory devices 16 may be used for storing thumbnail image files, as is explained in more detail below. The workstations 18 represent devices such as computer systems, personal computers, terminal equipment, or other types of network-connected devices that may access information from other devices on the network.

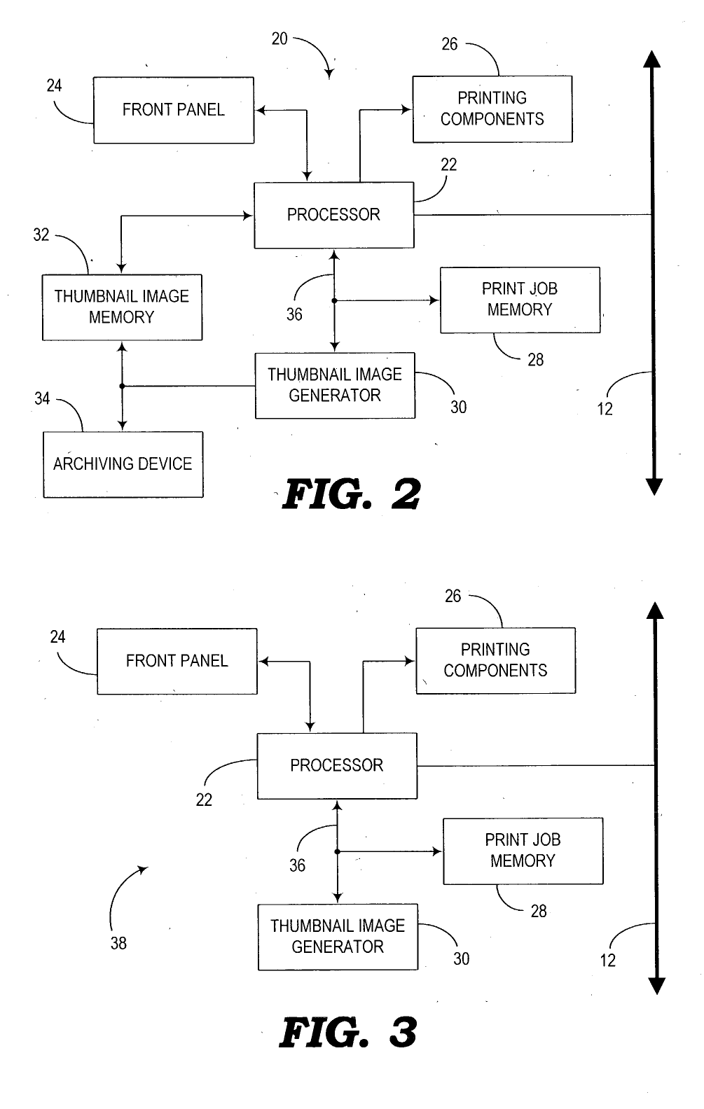

FIG. 2 is a schematic block diagram of an imaging device 20 representing a first embodiment of one or more of the imaging devices 14 shown in FIG. 1. The imaging device 20 contains a connection to the communication link 12 through a processor 22. The imaging device 20 contains several other elements connected directly or indirectly to the processor 22, such as a front panel 24, printing components 26, a print job memory 28, a thumbnail image generator 30, a thumbnail image memory 32, and an archiving device 34.

The processor 22 is described in more detail below and may include a configuration as shown in FIG. 6, as described below. The processor 22 receives files in Page Description Language (PDL) format and renders page frames containing bitmap data for printing. The processor 22 may also contain a web server for providing web-based access to the memory components of the imaging device 20.

The front panel 24, as is well known in the art, is a display device located physically on the outside of the imaging device 20. Typically, the front panel 24 contains liquid crystal display (LCD) elements or other suitable display elements for displaying information to a person located within reading distance of the front panel 24. Alternatively, the front panel 24 may be configured as a touchscreen device having soft buttons. The front panel 24 is associated with these soft buttons or other type of buttons (not shown) allowing a user to select printing parameters that may be displayed on the front panel 24. Most front panels are usually fairly small, e.g., about four to twelve square inches.

The printing components 26 represent the electronic and mechanical portions of the imaging device 20. However, since an understanding of the printing components 26 is not needed to clearly understand the present invention, the details of the printing components 26 will not be explained herein.

Further illustrated in FIG. 2, the print job memory 28 and thumbnail image generator 30 are connected to the processor 22 via line 36. The print job memory 28 is a storage device that stores received print jobs in either the PDL format or the page-frame format. A print job that is sent to the imaging device 20 may be stored in the print job memory 28 without being printed, or the print job may be stored in the print job memory 28 and simultaneously printed by the printing components 26. The term “print job” refers to a file or document to be printed that is received by the imaging device 20 via the communication link 12.

FIG. 2 further illustrates a thumbnail image generator 30 that is connected to line 36. The thumbnail image generator 30 operates in parallel with the print job memory 28 to create a thumbnail image of every page of every print job as it is being stored in the print job memory 28. As mentioned earlier, the term “thumbnail image” refers to a miniature version of a larger image and has a fraction of the resolution of the larger image.

With every thumbnail image created, the thumbnail image generator 30 further creates unique correlation information to link the thumbnail images to the corresponding pages of the print jobs. Therefore, when a page of a print job is identified using a thumbnail image, the correlation between the thumbnail image and the print job is used to perform management functions on the print job as described below. The thumbnail image generator 30 contains any suitable algorithm for reducing the large file size of the print job (e.g., 96 MB per page) into a more manageable file. For example, the thumbnail image generator 30 may use an averaging algorithm to achieve a small yet perceptible version of the full image.

The thumbnail image generator 30 may create a thumbnail image having any number of resolution sizes. The size of the thumbnail image may be selected by the user or may be determined automatically based on the type or characteristics of the file or document that is to be printed. For example, a smaller thumbnail image file size may be selected if the text or images in the print job are large and can be easily perceived when a thumbnail image is rendered with lower resolution. On the other hand, if a print job has small text and does not have a particularly unique layout, a thumbnail image file with greater resolution may be selected.

As an example, the available thumbnail image resolutions may include 640×480 pixels, 320×240 pixels, 200×150 pixels, and 100×75 pixels. To store a color thumbnail image with a size of 640×480 pixels, about 900 kilobytes (KB) of data are required. With a 320×240 size, about 225 KB are required. For a 200×150 thumbnail image, 88 KB are required, and with a 100×75 image, 22 KB. These file sizes represent a significant reduction in size from the 96 MB size that is used to store a single color page of the print job itself.

The thumbnail image generator 30 may further include a compression algorithm for compressing the thumbnail image file to an even smaller size. Appropriate compression algorithms based on the type of print job file may be used to compress a file to thereby consume less storage space. For example, to compress a printed page using a lossless algorithm, a file may typically be compressed by a 2:1 to 4:1 compression ratio down to about 25% to 50% of its original size. A lossy algorithm, such as JPEG, may be suitable for a print job having graphical images and no text. JPEG compression may typically compress a file by a 10:1 compression ratio down to about 10% of its original size.

The thumbnail image files created by the thumbnail image generator 30 are sent to one or both of two different storage devices. The first storage device is the thumbnail image memory 32 that contains a storage medium that allows the thumbnail image files to be retrieved by the processor 22. The thumbnail image files stored on the thumbnail image memory 32 can be electronically accessed by a workstation 18 via the processor 22 and communication link 12. Accessing the files may involve the use of a web-based system, as is explained in more detail below.

The second storage device is the archiving device 34, which creates a record on a removable and portable storage medium of all the generated thumbnail images. The archiving device 34 may be a compact disk burning device for writing thumbnail image information on a compact disk read-only memory (CD-ROM) or may be any suitable storage medium writing or burning device for archiving the thumbnail images on a portable storage medium. The archiving device 34 differs from the thumbnail image memory 32 in that it does not provide electronic access. through processor 22. Instead, the archiving device 34 writes thumbnail images on the portable storage medium for archiving records of the print jobs. The archiving device 34 is optional in this embodiment and may be removed if desired.

FIG. 3 is a block diagram of another exemplary imaging device 38 representing a second embodiment of one of the imaging devices 14 shown in FIG. 1. The imaging device 38 of FIG. 3 contains most of the elements of the imaging device 20 of FIG. 2, except that the thumbnail image memory 32 and the archiving device 34 have been omitted. In this embodiment, the thumbnail image generator 30 creates the thumbnail images, as mentioned above, and transmits the thumbnail image files to the memory devices 16 (FIG. 1) at remote locations along the communication link 12.

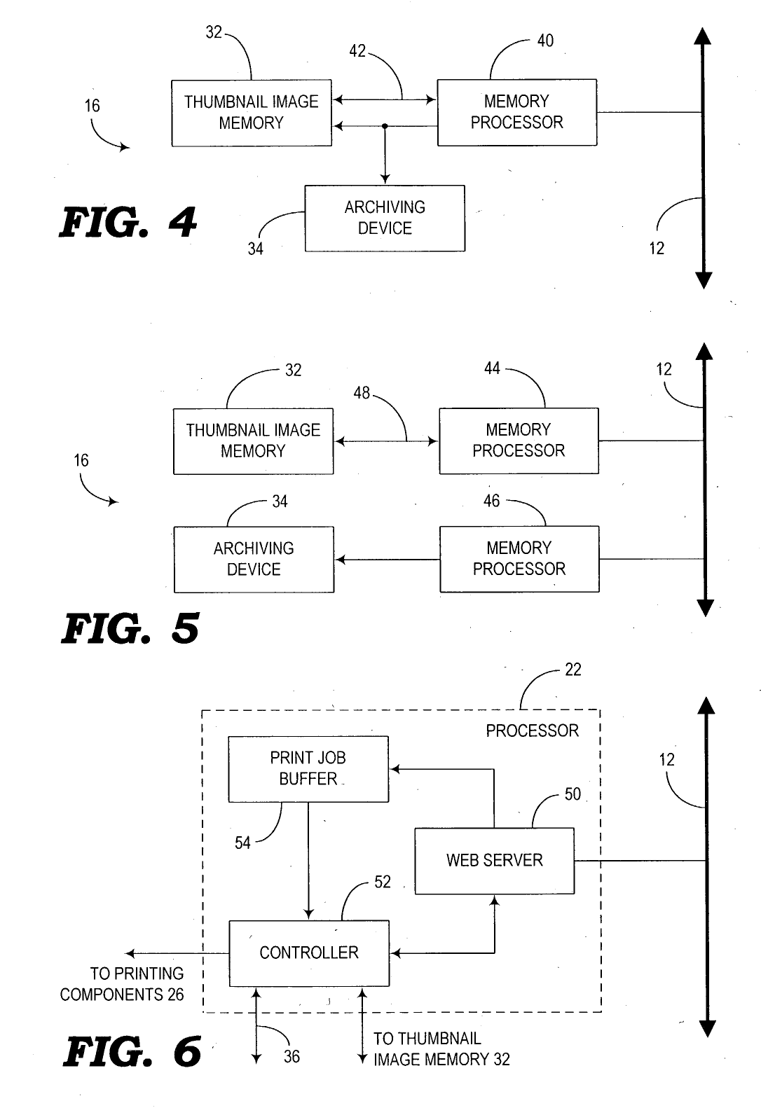

FIGS. 4 and 5 are block diagrams of exemplary embodiments of the memory devices 16 (shown in FIG. 1), which are used in conjunction with the imaging device 38 of FIG. 3. Since the imaging device 38 does not include a storage mechanism of its own for storing thumbnail image files, the memory devices 16 are connected to the communication link 12 to provide storage for the created thumbnail images.

FIG. 4 illustrates a first embodiment of memory devices 16, in which each memory device 16 is connected to the communication link 12 at a single location remote from the imaging device 38. The remote memory devices shown in FIG. 4 include thumbnail image memory 32 and archiving device 34, having similar configurations and functions as the corresponding components described with respect to FIG. 2. A memory processor 40 receives thumbnail image files sent from the imaging device 38 through the communication link 12. Once the files are received, the memory processor 40 stores the files in the thumbnail image memory 32. Furthermore, the memory processor 40 provides the thumbnail images of the print job files to the archiving device 34 for creating a permanent record of the thumbnail images.

As can be further seen in FIG. 4, a two-way communication link 42 is connected between the memory processor 40 and the thumbnail image memory 32. This communication link 42 allows the memory processor 40 to access the thumbnail image files stored in the thumbnail image memory 32 when needed. For example, a web server may be located in the memory processor 40 and thumbnail image files may be uploaded to the web server using a file transfer-protocol (FTP). Alternatively, a web server may be located in processor 22 (FIGS. 2 and 3) that uploads thumbnail image files from the thumbnail image memory 32 directly or via the memory processor 40. A web server, as disclosed herein, may provide web pages that display the stored thumbnail images and related information about the print jobs. The web server further provides an interactive interface allowing a user to manage print jobs. A description of an exemplary web server is described below with respect to FIG. 6.

FIG. 5 illustrates another embodiment of memory devices 16, wherein the thumbnail image memory 32 and the archiving device 34 of each memory device 16 are connected at different locations along the communication link 12, remote from the imaging device 38 of FIG. 3. As illustrated in FIG. 5, each memory device is connected to the communication link 12 via respective memory processors 44 and 46. The thumbnail image memory 32 is connected to the communication link 12 via memory processor 44 and the archiving device 34 is connected to the communication link 12 via memory processor 46. Again, a two-way communication link 48 is provided between the memory processor 44 and the thumbnail image memory 32 allowing two-way communication between the two elements. Thus, the memory processor 44 may store thumbnail image files onto the thumbnail image memory 32 and may access the thumbnail image files stored in the thumbnail image memory 32 to upload the files in a web server.

The connection between the memory processor 46 and the archiving device 34 is a one-way communication, whereby the thumbnail image files are transferred to the archiving device 34 where the thumbnail images are written onto a portable storage medium by the archiving device 34. Memory processor 46 does not access the files from the archiving device 34. Access to the files on the storage medium of the archiving device 34 can be made by other suitable mechanisms, e.g., a CD-ROM reader or other mechanism depending on the type of storage medium used with the archiving device 34.

The processor 22 and memory processors 40, 44, and 46 can be implemented in hardware, software, firmware, or a combination thereof. In the disclosed embodiments, the processors can be implemented in software or firmware that is stored in memory and that is executed by a suitable instruction execution system. If implemented in hardware, as in an alternative embodiment, the processors can be implemented with any or a combination of the following technologies, which are all well known in the art: a discrete logic circuit having logic gates for implementing logic functions upon data signals, an ASIC having appropriate combinational logic gates, a PGA, a FPGA, etc.

FIG. 6 is a block diagram of an embodiment of the processor 22 that is shown in FIGS. 2 and 3. The processor 22 contains a web server 50, a controller 52, and a print job buffer 54. The web server 50 connects the processor 22 to the communication link 12. The web server 50 may be a program that hosts electronic documents, commonly referred to as web pages, for remote retrieval over a network such as the World Wide Web. Web pages can be delivered on a number of formats including, but not limited to, Hyper-Text Markup Language (HTML) and eXtensible Markup Language (XML).

The web server 50 may implement Hyper-Text Transport Protocol (HTTP) and can host a web site or a web service. A web site provides a user interface by supplying web pages to a requesting client, such as a web browser. Web pages can be delivered in a number of formats including, but not limited to, HTML and XML. Web pages may be generated on demand using server side scripting technologies including, but not limited to, Active Server Pages (ASP) and Java Server Pages (JSP). A web page is typically accessed through a network address. The network address can take the form of a Uniform Resource Locator (URL), Internet Protocol (IP) address, or any other unique addressing mechanism. A web service provides a programmatic interface which may be exposed using a variety of protocols layered on top of HTTP, such as Simple Object Access Protocol (SOAP).

Print jobs that are retrieved by the web server 50 from the communication link 12 are input into the print job buffer 54, which may contain volatile memory, such as RAM, for temporarily storing the print jobs as they are received. Printing instructions related to the print job are input into the controller 52, which further controls the operation of the elements of the imaging device 20, 38 by sending control signals to the appropriate elements. The controller 52 retrieves the print jobs, which are received in-the PDL format, from the print job buffer 54. The controller 52 can render page frames from the PDL files and transmit the rendered data to the printing components 26 for printing. The controller further provides the print job, either in PDL or page-frame form, along line 36 leading to the print job memory 28 and thumbnail image generator 30 (FIGS. 2 and 3) for storing print jobs and generating thumbnail images.

The controller 52 may be connected directly to the thumbnail image memory 32. With respect to the imaging device 20 of FIG. 2, the controller 52 is connected directly to the thumbnail image memory 32 located within the imaging device 20 itself. With respect to the imaging device 38 of FIG. 3, the controller 52 is connected to the remote thumbnail image memory 32 (FIGS. 4 and 5) via the web server 50 and communication link 12. The controller 52 uploads the thumbnail image files from the thumbnail image memory 32 to the web server 50 using FTP. With the thumbnail image files uploaded into the web server 50, a user at a workstation 18 (FIG. 1) may access the files using a browser (described below) to view web pages transferred from the web server 50 using HTTP, for example.

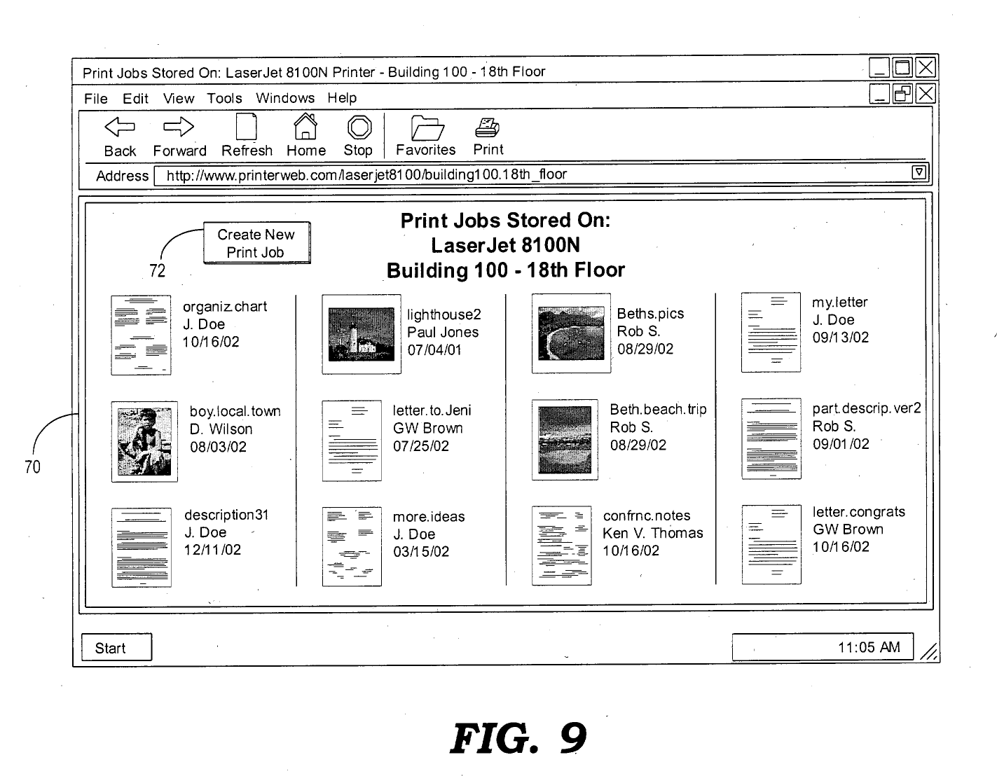

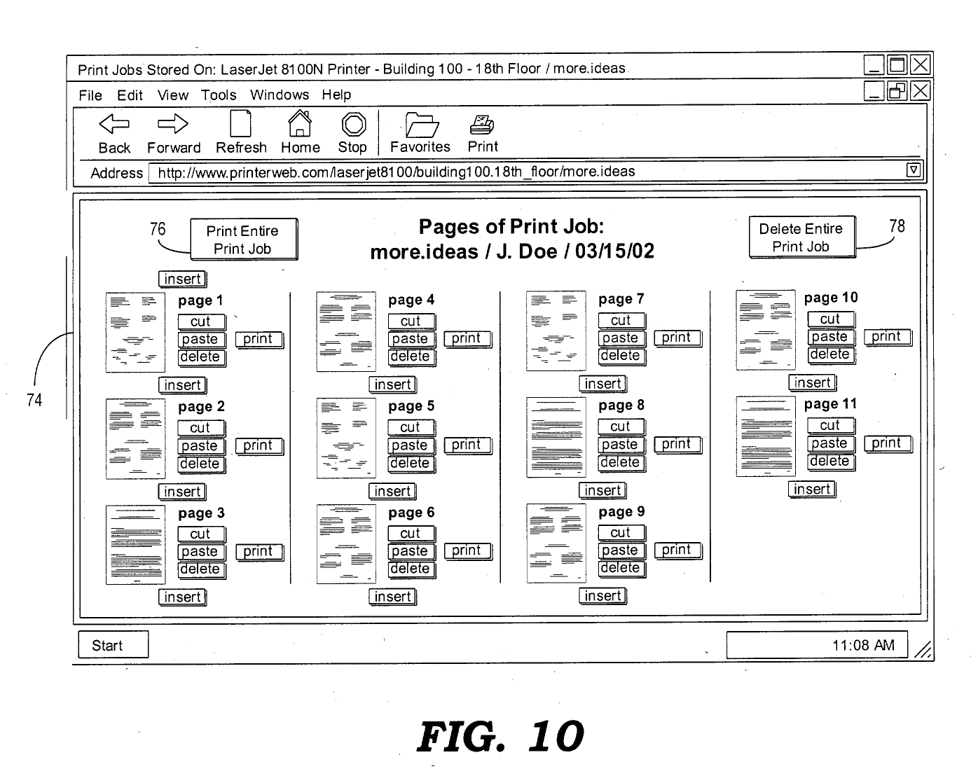

The web server 50 provides web pages, as shown in FIGS. 9 and 10, to the browser of the workstation 18. The web pages provide information regarding the stored print jobs and show a graphic display of the pages of the print jobs as represented by the thumbnail images. Furthermore, the web pages allow the user to interact with interface mechanisms on the graphic display to manage the print jobs. For example, the user may perform functions such as viewing thumbnail images of the pages of the print jobs, reprinting a stored print job, reprinting a single page of a print job, etc. This web-based management system may further allow the user to delete individual pages of a print job, delete the entire print job, rearrange pages within a print job, and even create a new print job by inserting stored pages of other print jobs.

Since the thumbnail images contain a relatively small file size, as mentioned above, downloading the thumbnail images to a browser does not require the transfer of large files and thus, allows for quicker and easier downloading. Another advantage of this configuration is that the web server 50 may provide web page information while the imaging device 20, 38 is busy printing. The two functions do not interfere with each other and may be performed simultaneously.

The thumbnail image generator 30, the thumbnail image memory 32, and web server 50, in combination, can define a thumbnail image displaying and managing program having network accessibility. The thumbnail image displaying and managing program contains an ordered listing of executable instructions for implementing logical functions and can be embodied in any computer-readable medium for use by an instruction execution system, apparatus, or device, such as a computer-based system, processor-controlled system, or other system that can fetch the instructions from the instruction execution system, apparatus, or device and execute the instructions. A “computer-readable medium” can be any medium that can contain, store, communicate, propagate, or transport the program for use by the instruction execution system, apparatus, or device.

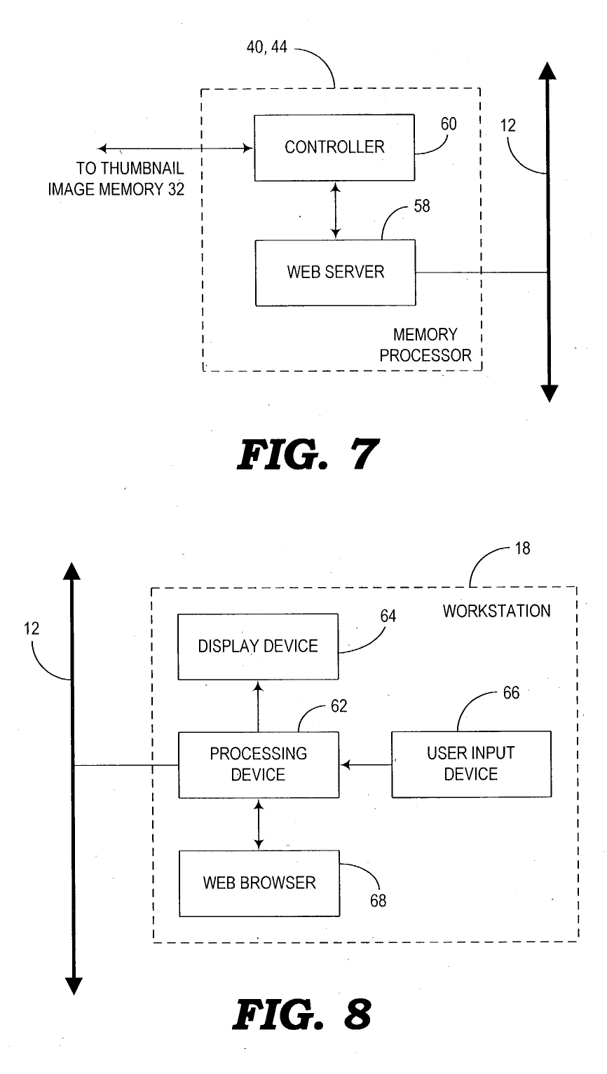

FIG. 7 is a schematic block diagram of an embodiment of one of the memory processors 40, 44 shown in FIGS. 4 and 5. The memory processor 40, 44 contains a web server 58 connected to the communication link 12. The web server 58 is connected to a controller 60, which controls and the transfer of thumbnail image data to and from the thumbnail image memory 32. The controller 60 uploads thumbnail image files from the thumbnail image memory 32 into the web server 58, which sends the thumbnail image files and corresponding information concerning individual print jobs to the web browser of a workstation 18 accessing the files of the web server 58.

FIG. 8 is a block diagram of an embodiment of one of the workstations 18 shown in FIG. 1. The workstation 18 may be a computer or other suitable data processing device. The exemplary workstation 18 of FIG. 8 includes a processing device 62, a display device 64, a user input device 66, and a web browser 68. This configuration is merely an example of one of many possible configurations that may be constructed for allowing a user to communicate with remote devices via the communication link 12.

The processing device 62, for example, may be a central processing unit (CPU) of a computer. Connected to the processing device 62 is the display device 64, which may be a computer monitor, display screen, or other suitable visual communication device for visually communicating information to a user. The user input device 66 is also connected to the processing device 62. The user input device 66 may be a keyboard;, computer mouse, and/or other input devices allowing the user to communicate information to the processing device 62. By manipulating the user input device 66, the user can access the thumbnail images, alter the order of pages of a print job, and delete or print a print job. The web browser 68 is illustrated as being connected to the processing device 62, but may alternatively be included within the processing device 62, as is well known. The web browser 68 allows the user to browse the network and access web sites. For instance, by addressing the web server 50 shown in FIGS. 6 and 7 using a pre-established URL, the web browser 68 may download web pages from the web server 50 to view information concerning the stored printjobs. The processing device 62 may then display the web pages on the display device 64.

FIG. 9 is a view of a screen display showing an example of a web page 70 that may be downloaded from the web server 50, 58 and displayed on the display device 64. The web page 70 retrieved from web server 50, 58 includes a title at the top of the page to identify which imaging device is being characterized. For example, the title may read “Print Jobs Stored On:” followed by the specific imaging device on which print jobs are stored. The title may also include location information of the imaging device.

The web page 70 further includes information about the print jobs that are stored on the identified imaging device. For example, the web page 70 displays a thumbnail image of the first page, or other selected page, from each print job. The thumbnail images are retrieved from the thumbnail image memory 32. In this example, twelve thumbnail images are shown. It should be noted, however, that more or fewer thumbnail images may be displayed. Along with a thumbnail image for each print job, the web page 70 further includes information related to the print job, shown next to the respective thumbnail images. The related information may include a title given to the print job, the author or originator who submitted the print job to the imaging device, the date that the print job was submitted to the imaging device, etc.

The web page 70 shown in FIG. 9 may include other features that allow a user to manage the print jobs stored on a particular imaging device. For example, the web page 70 may include a button 72, as illustrated on the top of the web page 70, allowing a user to initiate the creation of a new print job. Creating a new print job may include the process of accessing the pages of individual print jobs, cutting or copying select pages, and pasting or inserting the pages into blank pages of the new print job. The user may perform various management functions such as deleting selected print jobs, printing selected print jobs, etc. The user may also have the option to select a particular print job to perform management functions on the individual pages of the print job.

When a particular print job is selected, the web server 50, 58 provides a second web page as shown in FIG. 10.

FIG. 10 illustrates another view of a screen display showing a second web page 74 that may be shown on the display device 64. By selecting a particular print job from web page 70 of FIG. 9, the user may view details of the individual pages of the selected print job on web page 74. The web page 74 may include a title at the top to identify the title of the selected print job. The title may also include other suitable information, such as the identity of the imaging device on which the selected print job is stored, which may be the same title mentioned earlier with respect to the first web page 70. Details of the selected print job may be displayed, such as the page numbers and thumbnail images of each page. Other details may be displayed for indicating when each page was created or whether a particular page had been inserted by a management function after the print job was originally stored.

The web page 74 shown in FIG. 10 may further include management buttons allowing the user to perform desired functions on the selected print job or on individual pages of the selected print job. For example, the management buttons may include buttons for moving, cutting, pasting, deleting, inserting, printing, etc. Move buttons, or cut buttons, allow selected page to be moved to a different location within the selected print job or into a different print job. The cutting and pasting buttons allow pages to be removed from one location within a print job and placed in a different location. Insert buttons may be used to show possible locations where a selected page may be inserted. Delete buttons may be used for deleting a page. Print buttons may be used for printing a selected page.

Web page 74 further includes a button 76 that may be selected if the user desires to print the entire print job. After the user has had the opportunity to view the thumbnail images to determine the pages of the print job, the user may select the button 76 to print the print job. Another situation for the user may make it necessary to rearrange or delete some of the pages of the print job before the user decides to print the entire print job. Another action that the user may take is selecting button 78, which deletes the entire print job. It may be determined, after viewing the thumbnail images, that the print job is no longer needed and may be deleted using button 78.

Furthermore, two or more web pages, displaying the thumbnail image information, may be opened at the same time. Having multiple pages opened simultaneously allows a user to re-arrange pages and/or insert pages from one print job into a specific location within another print job. With the visual guidance of the thumbnail images, the management of the pages of the print jobs is significantly simplified. From a workstation 18, a user may be able to easily re-arrange pages of print jobs with the confidence that the particular pages have been correctly identified by the thumbnail image representations. In addition, with the additional information provided by the thumbnail images, the user may delete a page from a-print job or delete an entire print job knowing which pages are actually being deleted. Control signals from the user input device 66 provide commands for instructing the respective imaging device 14 to cut, paste, delete, print, etc. The processors 22, 40, 44, and 46 can re-save revised print jobs in the print job memory 28 and thumbnail images in the thumbnail image memory 32. After alterations are made to an existing print job, based on the control signals from the user, the archiving device 34 can create new thumbnail images of the altered print job.

We claim:

1. A network printing system comprising:
an imaging device comprising:
a processor for receiving a print job;
a thumbnail image generator for creating a thumbnail image corresponding to a page of the print job received by the processor; and
a print job memory for storing the print job received by the processor;
a thumbnail image memory for storing the thumbnail image created by the thumbnail image generator;
a web server; and
a workstation having a web browser capable of accessing the thumbnail image stored in the thumbnail image memory via the web server.

2. The printing system of claim 1, wherein the thumbnail memory is part of the imaging device.

3. The printing system of claim 1, wherein the thumbnail memory is linked to the thumbnail image generator and the web server via a memory processor remote from the imaging device.

4. The printing system of claim 3, wherein the web server resides on the memory processor.

5. The printing system of claim 1, wherein the web server resides on the imaging device processor.

6. The printing system of claim 1, wherein the web server is configured to provide a first web page containing the thumbnail image corresponding to the print job to the web browser.

7. The printing system of claim 6, wherein the web server is configured to provide a second web page containing a thumbnail image of each page of the print job and management buttons that allow a user to manage the pages of the print jobs.

8. The printing system of claim 1, further comprising an archiving device for storing the thumbnail images created by the thumbnail image generator on a portable storage medium.

9. The printing system of claim 1, wherein the thumbnail image generator comprises a generator for creating a thumbnail image of each page of the print job received by the processor.

10. An imaging device configured for connection to a network, the imaging device comprising:
a processor configured to receive a print job through the network;
a thumbnail image generator configured to create a thumbnail image of a page of the print job received by the processor, the thumbnail image being accessible to workstations connected to the network; and
a print job memory configured to store the print job received by the processor.

11. The imaging device of claim 10, further comprising a thumbnail image memory configured to store the thumbnail image created by the thumbnail image generator.

12. The imaging device of claim 10, further comprising an archiving device configured to store the thumbnail image on a portable storage medium.

13. The imaging device of claim 10, wherein the processor is further configured to transmit the thumbnail image created by the thumbnail image generator to a remote memory device having a web server.

14. The imaging device of claim 10, wherein the processor comprises a web server, a print job buffer, and a controller.

15. The imaging device of claim 14, wherein the web server is configured to provide a first web page containing a thumbnail image corresponding to a print job to a web browser on a workstation.

16. The imaging device of claim 15, wherein the web server is further configured to provide a second web page containing thumbnail images of each page of the print job.

17. The imaging device of claim 16, wherein the second web page further comprises buttons allowing a user to move, cut, paste, insert, delete, or print selected pages of the selected print job.

18. A web server for providing access to print jobs stored on an imaging device, the web server comprising:
means for receiving a request from a workstation connected to a network;
means for accessing a thumbnail image stored in a thumbnail image memory, the thumbnail image corresponding to a page of a print job; and
means for downloading a web page containing the thumbnail image corresponding to the print job to a browser in the workstation.

19. The web server of claim 18, wherein the means for downloading web pages comprise means for downloading a first web page having a thumbnail image for each print job on a particular imaging device.

20. The web server of claim 19, wherein the first web page further comprises the title of the print job, the name of the person who sent the print job to the imaging device, and the date on which the print job was sent to the imaging device.

21. The web server of claim 20, wherein the first web page further comprises a button allowing a user to create a new print job.

22. The web server of claim 19, wherein the means for downloading web pages further comprise means for downloading a second web page having a thumbnail image of each page of a selected print job.

23. The web server of claim 22, wherein the second web page further comprises management buttons allowing a user to cut, paste, delete, move, insert, or print selected pages of the selected print job.

24. The web server of claim 22, wherein the second web page further comprises buttons allowing a user to perform a function selected from the list consisting of printing the entire print job and deleting the entire print job.

25. A workstation for accessing imaging devices connected to a network, the workstation comprising:
a processing device configured for connection to the network;
a user input device in communication with the processing device, the user input device allowing a user to enter selection information;
a web browser in communication with the processing device, the web browser accessing a thumbnail image from a web server of an imaging device, the thumbnail image corresponding to a page of a print job stored on the imaging device; and
a display device in communication with the processing device, the display device showing web pages downloaded from the web server, the web pages comprising the thumbnail image corresponding to the print job.

26. A computer program stored on a computer-readable medium, the computer program comprising:
logic configured to create a thumbnail image corresponding to a page of a print job stored on an imaging device;
logic configured to store the thumbnail image;
logic configured to access the thumbnail image through a web server; and
logic configured to download web pages to a web browser, the web pages comprising the thumbnail image.

27. The computer program of claim 26, further comprising:
logic configured to store the print job; and
logic configured to correlate the thumbnail image to the page of the print job.

28. The computer program of claim 26, further comprising logic configured to receive a selection of an imaging device on which thumbnail images corresponding to print jobs are stored.

29. The computer program of claim 28, wherein the logic configured to download web pages further comprises:
logic configured to download a first web page having a thumbnail image for each print job on the selected imaging device, the first web page further comprising the title of each print job and the person who sent each print job to the imaging device;
logic configured to receive a selection of a print job; and
logic configured to download a second web page having a thumbnail image for each page of the selected print job.

30. A method of managing print jobs, the method comprising:
creating a thumbnail image from a print job;
storing the print job in a print job memory;
storing the thumbnail image on an accessible storage medium; and
accessing the thumbnail image stored on the accessible storage medium.

31. The method of claim 30, wherein creating a thumbnail image further comprises creating one thumbnail image for each page of the print job.

32. The method of claim 30, further comprising:
correlating the pages of the stored print job with the stored thumbnail images.

33. The method of claim 30, wherein accessing the thumbnail images further comprises:
browsing the network;
accessing a web site related to a selected imaging device;
downloading a web page, the web page comprising the thumbnail images of each print job stored on the selected imaging device;
downloading additional information about each print job; and
displaying the downloaded web page and information on a display device.

34. The method of claim 33, further comprising:
selecting a print job from the web page of the print jobs of the selected. imaging device;
downloading a second web page, the second web page comprising a thumbnail image for each page of the selected print job; and
displaying the second web page on the display device.

35. The method of claim 34, further comprising:
selecting a page from the selected print job; and
performing at least one management function on the selected page, the at least one management function taken from the list consisting of cutting, pasting; moving, inserting, deleting, and printing.
